(19) United States
(12) Patent Application Publication
(10) Pub. No.: US 2009/0284541 A1
(43) Pub. Date: Nov. 19, 2009

(54) SPECIAL EFFECT PROCESSING SYSTEM AND METHOD

(75) Inventor: HONG-LIANG LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/240,018

(22) Filed: Sep. 29, 2008

(30) Foreign Application Priority Data
May 16, 2008 (CN) 200810301596.3

(51) Int. Cl. G09G 5/00

(52) U.S. Cl. 345/581

(57) ABSTRACT

A special effect processing system of a digital photo frame (DPF) is provided, including a shake sensing unit configured to detect if the DPF is being shaken, a shake frequency calculating unit configured to calculate a shake frequency of the DPF, an image special effect processing unit configured to transform an original image displayed in the DPF when the shake frequency of the DPF is greater than a predetermined reference frequency, and an image special effect restoring unit configured to restore the transformed image to the original image when the shake frequency of the DPF is lower than the reference frequency.

### BACKGROUND

1. Technical Field

The present invention relates to a special effect processing system and method used for a digital photo frame.

2. General Background

Digital photo frames (DPFs) are becoming more and more popular because of the convenience in browsing, selecting, and manipulating the digital photos stored therein. A typical DPF includes a function of applying special effects while the photo image is shown. However, the special effect is performed only when a predetermined command is selected from a menu in the DPF.

### BRIEF DESCRIPTION OF THE DRAWINGS

FIG. 1 is a block diagram of an embodiment of a special effect processing system for a digital photo frame.

FIG. 2 is a flow diagram of an embodiment of a special effect processing method.

### DETAILED DESCRIPTION OF THE EMBODIMENTS

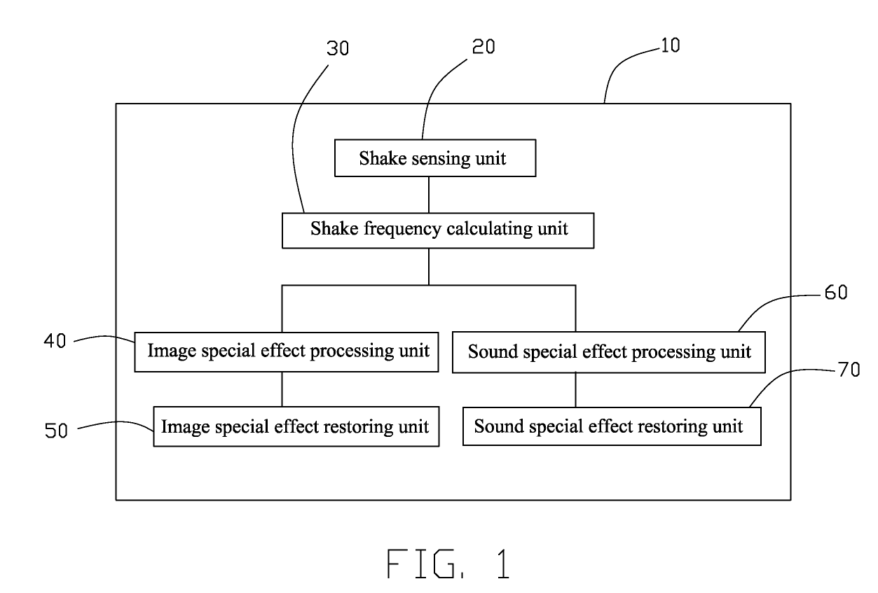

Referring to FIG. 1, a processing system for performing special effects on images displayed by a digital photo frame (DPF) 10 includes a shake sensing unit 20 for sensing if the DPF 10 is in a shake state, a shake frequency calculating unit 30 for calculating the shake frequency of the DPF 10 in the shake state, an image special effect processing unit 40 for transforming an original image displayed on the DPF 10, thereby yielding an altered image, an image special effect restoring unit 50 for restoring the altered image to the original image, a sound special effect processing unit 60 for outputting sound special effects, and a sound special effect restoring unit 70 for decreasing a degree of the sound special effect or removing the sound.

The shake sensing unit 20 detects if the DPF is in a shake state. If the DPF is in a shake state, the shake sensing unit 20 sends an interrupt signal to a microprocessor of the DPF 10. The microprocessor receives the interrupt signal and sends a control signal to the shake frequency calculating unit 30 to calculate a shake frequency of the DPF. If the orientation of the DPF 10 is changed N times in a time period t, the shake frequency is equal to N divided by t. A reference shake frequency is preset in the DPF 10. When the shake frequency of the DPF 10 is greater than the reference shake frequency, the image special effect processing unit 40 and the sound special effect processing unit 60 are initiated to process the image or play a sound.

The image special effect processing unit 40 performs different kinds of image special effects to the images in the DPF, such as broken and crumpled effects. One type of the image special effect is to cut the image into a number of image fragments having a same shape and size. An original position of each of the image fragments and a total amount of the image fragments are recorded in the DPF 10. When the image special effect processing is initiated, the image fragments are displaced or removed from original positions. The degree of the image and sound special effects increases as an effective shake time of the DPF in the shake state increases. The highest degree of the image and sound special effects occurs when the effective shake time reaches a predetermined maximum value Tmax.

When the DPF 10 is in a shake state, and an actual shake time of the shake state is less than Tmax, the effective shake time is equal to the actual shake time. If the actual shake time is longer than Tmax, the effective shake time is equal to Tmax. The special effect is recursively applied on the image. For example, when the effective shake time reaches a first value of T1, the special effect processing unit 40 transforms the original image to get a first special effect degree transformed image; when the effective shake time reaches a second value of T2, the special effect processing unit 40 performs transformation on the first special effect degree transformed image to get a second special effect degree transformed image. When the effective shake time reaches the preset maximum value Tmax, the image is transformed to the altered image having a highest special effect degree. At this time, all of the image fragments are moved to final positions and remain in a current special effect view if the DPF 10 remains in the shake state.

When the state of the DPF 10 changes from a shake state to an idle state, the shake frequency calculating unit 30 detects that the shake frequency of the DPF 10 is lower than the reference shake frequency, the transformed image is gradually restored to the original image view by the image special restoring unit 50. In one embodiment, if the DPF remains in an idle state before the transformed image is restored to the original image, the time to restore the transformed image is substantially equal to the effective shake time of the shake state. If the DPF 10 is switched from the idle state again to the next shake state before the transformed image is restored to the original image view, and the shake frequency calculating unit 30 detects that the shake frequency is greater than the reference frequency, the image special effect processing unit 40 transforms the current image again. The effective shake time of the current state is defined by subtracting the image special effect restoring time of the idle state from the effective shake time of a first shake state and then adding the actual shake time of a second shake state of DPF 10. For example, if the DPF 10 is effectively shaken 5 seconds in the first shake state, and is shaken 2 seconds again while the transformed image is being restored for 3 seconds, the effective shake time of the DPF 10 is (5−3)+2=4 seconds. The special effect degree of the transformed image at this time corresponds to the special effect degree when the effective shake time of the DPF is 4 seconds.

The working principle of the sound special effect processing unit 60 is similar to that of the image special effect processing unit 40. When the shake frequency of the DPF 10 is greater than the reference frequency, the sound special effect processing unit 60 controls the DPF 10 to play music or other special effect sound preset in the DPF 10.

Similar to the image special effect processing unit 50, when the DPF 10 has stopped shaking, the sound special effect restoring unit 60 controls the DPF to shut off or turn down the volume of special effect music or sound.

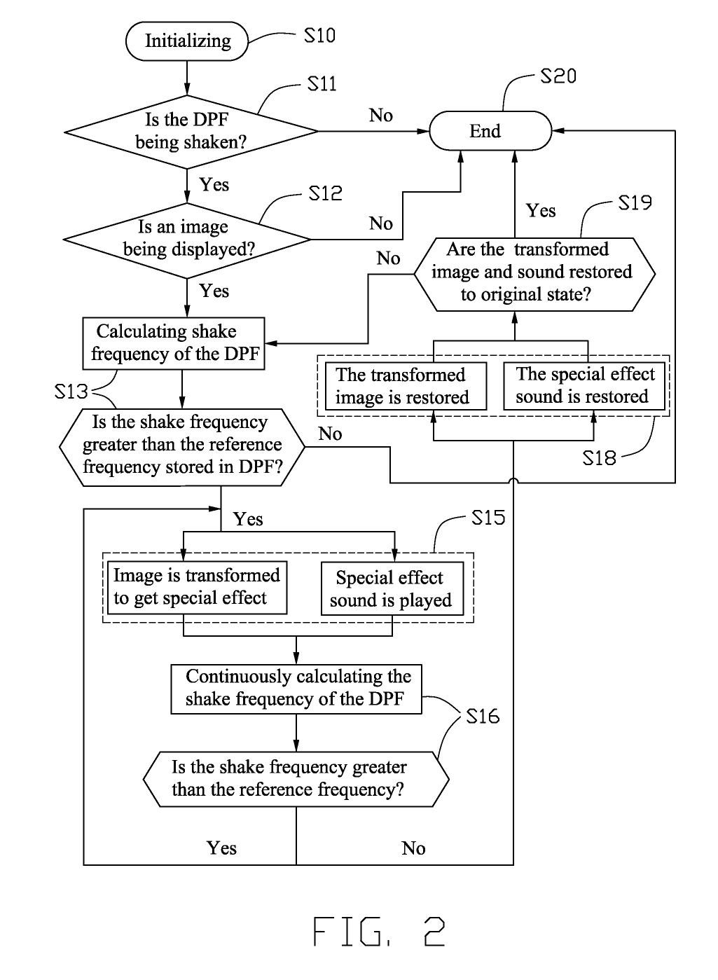

FIG. 2 is a flowchart illustrating one embodiment of a special effect processing method. Depending on the embodiment, certain of the steps described below may be removed, others may be added, and the sequence of steps may be altered.

In step S10, the DPF 10 is started to execute initialization.

In step S11, the shake sensing unit 20 determines if the DPF is being shaken. If the DPF is being shaken, the method continues to step S12. If the DPF is not being shaken, the method continues to end step S20.

In step S12, the DPF system detects if a photo is displayed in the DPF 10. If the photo is displayed, the method continues to step S13. If not, the method continues to end step S20.

In step S13, the shake frequency calculating unit 30 calculates the current shake frequency of the DPF 10 and determines if the shake frequency of the DPF is greater than the reference frequency stored in the DPF. If the shake frequency is greater than the reference frequency, the method continues to step S15. If not, the method continues to end step S20.

In step S15, the image special effect processing unit 40 transforms the image to get the transformed image, and the sound special effect processing unit 60 controls the DPF 10 to play special effect music.

Continuing to step S16, the shake frequency calculating unit 30 is continuously calculating the shake frequency and determining if the shake frequency is greater than the reference frequency. If the shake frequency is greater than the reference frequency, the method returns to step S15 to maintain the special effect degree of the transformed image. If not, the method continues to step S18.

In step S18, the image special effect restoring unit 50 and/or the sound special effect restoring unit 70 restore the transformed image and/or sound to the original state.

Moving to step S19, the DPF determines if the transformed image and sound has been restored to the original state. If the image is in its original state, the method continues to end step S20 and all the units of the DPF 10 are returned to the original state to wait for next circulation of the method. If not, the method returns to step S13.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A special effect processing system of a digital photo frame (DPF), comprising:
a shake sensing unit configured to detect if the DPF is being shaken;
a shake frequency calculating unit configured to calculate a shake frequency of the DPF;
an image special effect processing unit configured to transform an original image displayed in the DPF to a transformed image when the shake frequency of the DPF is greater than a predetermined reference frequency; and
an image special effect restoring unit configured to restore the transformed image to the original image when the shake frequency of the DPF is lower than the reference frequency.

2. The special effect processing system of claim 1, further comprising a sound special effect processing unit configured to control the DPF to play music or sound when the shake frequency of the DPF is greater than the reference frequency.

3. The special effect processing system of claim 2, further comprising a sound special effect restoring unit configured to control the DPF to shut off or turn down a volume of the special effect music when the shake frequency of the DPF is lower than the reference frequency.

4. The special effect processing system of claim 1, wherein the image special effect processing unit is capable of controlling degrees of the image special effect; the degrees of special effect increases as an effective shake time of the DPF increases.

5. The special effect processing system of claim 4, wherein the highest degree of the special effect of the transformed image occurs when the effective shake time is equal to a predetermined maximum shake time.

6. The special effect processing system of claim 5, wherein an actual shake time is equal to the effective shake time of the DPF if the actual shake time is less than the maximum shake time, and the effective shake time is equal to the maximum shake time if the actual shake time is longer than the maximum shake time.

7. A special effect processing method for digital photo frame (DPF), comprising:
detecting if the DPF is being shaken;
detecting if a photo image is being displayed when the DPF is shaken;
calculating a current shake frequency by a shake frequency calculating unit when the image is being displayed; and
transforming the image to get a transformed image having a special effect by an image special effect processing unit when the shake frequency is greater than a predetermined reference frequency in the DPF.

8. The special effect processing method of claim 7, further comprising calculating continuously the current shake frequency of the DPF by the shake frequency calculating unit, and maintaining the special effect of the transformed image if the current shake frequency of the DPF is greater than the reference frequency.

9. The special effect processing method of claim 8, further comprising calculating continuously the current shake frequency of the DPF by the shake frequency calculating unit, and restoring the transformed image to the original image by an image special effect restoring unit if the current shake frequency of the DPF is lower than the reference frequency.

10. The special effect processing method of claim 9, further comprising transforming the transformed image if the shake frequency of the DPF is greater than the reference frequency during restoring, such that the image is transformed again to get a higher special effect degree base on a current special effect degree by the image special effect processing unit.

11. The special effect processing method of claim 9, wherein in response to determining that the special effect image is restored to an original state, returning to detecting if the DPF is being shaken.

12. The special effect processing method of claim 7, wherein a degree of the special effect of the image increases as an effective shake time of the DPF increases.

13. The special effect processing method of claim 12, wherein the highest degree of the special effect of the image occurs when the effective shake time is equal to a predetermined maximum shake time.

14. The special effect processing system of claim 13, wherein the transformed image remains in the highest special effect degree when the effective shake time is greater than the predetermined maximum shake time.

15. The special effect processing system of claim 14, wherein an actual shake time is equal to the effective shake time if the actual shake time is less than the maximum shake time, and the effective shake time is equal to the maximum shake time if the actual shake time is longer than the maximum shake time.

16. The special effect processing method of claim 7, wherein the DPF plays a special effect music or sound by a sound special effect processing unit when the shake frequency of the DPF is greater than the reference frequency.

17. The special effect processing method of claim 7, wherein a volume of the music or sound is gradually decreased by a sound special effect restoring unit when the shake frequency of the DPF is lower than the reference frequency.
